(19) United States
(12) Patent Application Publication
(10) Pub. No.: US 2026/0356249 A1
(43) Pub. Date: Nov. 12, 2026

(54) VEHICLE SEAT

(71) Applicant: TOYOTA BOSHOKU KABUSHIKI KAISHA, Aichi (JP)

(72) Inventor: Tadasuke HIGUCHI, Aichi-gun, Aichi (JP)

(73) Assignee: TOYOTA BOSHOKU KABUSHIKI KAISHA, Aichi (JP)

(21) Appl. No.: 19/668,045

(22) Filed: May 5, 2026

(30) Foreign Application Priority Data
May 12, 2025 (JP) 2025-079581

(51) Int. Cl. B60N 2/02; B60N 2/14; H02K 5/173; H02K 7/12; H02K 21/16

(52) U.S. Cl. CPC B60N 2/02246; B60N 2/146; H02K 5/1737; H02K 7/12; H02K 21/16

(57) ABSTRACT

A vehicle seat is provided. The vehicle seat includes a rotary support that is configured to rotatably support a seat body about a vertical axis and that also serves as a rotor of an electric motor, and stator coils configured to generate a rotational force in the rotary support.

### CROSS-REFERENCE TO RELATED APPLICATIONS

This application claims the benefit of Japanese Patent Application No. 2025-079581 filed on May 12, 2025 with the Japan Patent Office, the entire disclosure of which is incorporated herein by reference.

### BACKGROUND

The present disclosure relates to a vehicle seat in which a seat body is rotatable about a vertical axis.

For example, a vehicle seat disclosed in Japanese Unexamined Patent Application Publication No. 2024-8789 is configured such that a rotatable plate to which a seat body is coupled is rotated by an electric actuator. Specifically, the actuator is a unit in which an electric motor and a reducer are integrated.

An output shaft of the actuator is provided with a smaller gear. The rotatable plate is provided with a larger gear meshing with the smaller gear. Rotation of the electric motor causes rotation of the smaller gear reduced by the reducer, thus rotating the rotatable plate.

### SUMMARY

In the vehicle seat disclosed in Japanese Unexamined Patent Application Publication No. 2024-8789, the output of the electric motor is transmitted to the rotatable plate via the reducer, the smaller gear, and the larger gear in this order. Thus, a reduction in the number of components and a reduction in the height are difficult. The present disclosure discloses one example of a vehicle seat with this point taken into consideration.

For example, it is desirable that a vehicle seat to be mounted in a vehicle comprise at least one of the following elements.

Specifically, the elements are a rotary support that is configured to rotatably support a seat body about a vertical axis and that functions also as a rotor of an electric motor, and stator coils configured to generate a rotational force in the rotary support.

This eliminates, in the vehicle seat, the need for a reducer and reducing gears, such as a smaller gear and a larger gear.

Specifically, the diameter of the rotary support is dimensioned according to the width of the seat body. Thus, the diameter of the rotary support, that is, the diameter of the rotor is dimensioned to be extremely large compared with that in a common electric motor used for the vehicle seat.

Accordingly, even when the height of the rotary support, that is, the axial dimension of the rotor is small, sufficient torque that can rotate the seat body is generated in the rotary support. This in turn may enable, in this vehicle seat, a reduction in the number of components and a reduction in the height.

In the meantime, in a configuration, as in the invention disclosed in Japanese Unexamined Patent Application Publication No. 2024-8789, in which a power transmission path from the electric motor to the rotatable plate is constantly continuous via multiple gears, it is effectively impossible to rotate the rotatable plate manually.

To cope with this, a configuration in which a clutch is provided along the power transmission path would make it possible to rotate the rotatable plate manually. However, such a configuration would result in an increase in the number of components and a further increase in the height.

In this respect, the rotary support in the vehicle seat is a rotor of the electric motor, and thus, while the stator coils are not energized, the rotary support can, in principle, rotate with no restraint. Accordingly, since no clutch is required for this vehicle seat, issues such as an increase in the number of components and an increase in the height caused by addition of a clutch do not arise.

For example, the vehicle seat may be configured as follows. It is desirable that the vehicle seat further comprise a lock mechanism configured to restrain rotation of the rotary support, and that the lock mechanism include: a lock member configured to shift between a locking position in which the lock member is engaged with an engagement portion provided on the rotary support and a non-locking position in which such engagement is released; and an actuator configured to shift a position of the lock member.

It is desirable that the vehicle seat further comprise: rolling elements configured to be in rolling contact with the rotary support to support the rotary support; and a bearing ring with an annular shape, with which the rolling elements are in rolling contact, the bearing ring being configured to guide rolling of the rolling elements, that the actuator be an electromagnetic actuator generating an electromagnetic force and include a fixed iron core portion forming a magnetic path in the actuator, and that the fixed iron core portion be a one-piece article integral with the bearing ring and of the same material as the bearing ring.

Moreover, it is desirable that a portion of the rotary support facing the stator coils have permanent magnets arranged thereon.

### BRIEF DESCRIPTION OF THE DRAWINGS

An example embodiment of the present disclosure will be described hereinafter with reference to the accompanying drawings, in which:

FIG. 1 is a view showing a vehicle seat;

FIG. 2 is an exploded view of a rotary support device;

FIG. 3 is an exploded view of a device body;

FIG. 4 is a view showing a structure of a rotary support;

FIG. 5 is a view showing a structure of a stator;

FIG. 6 is a view showing a structure of the device body;

FIG. 7 is a view showing a structure of the device body;

FIG. 8 is a view showing a structure of the device body; and

FIG. 9 is a view showing a structure of the device body.

### DETAILED DESCRIPTION OF EXEMPLARY EMBODIMENTS

“Embodiments” described below show examples of embodiments that fall within the technical scope of the present disclosure. That is, invention-specifying matters and so on recited in the appended claims are not limited by specific configurations, structures, and so on indicated in the below-described embodiments.

The below-described embodiments are examples in which a vehicle seat according to the present disclosure is applied to a seat to be mounted in a vehicle such as an automobile (hereinafter referred to as a vehicle seat). Arrows indicating directions, hatched lines, and so on shown in the drawings are provided for the purpose of easier understanding of mutual relationships between the drawings, shapes of members or portions, and so on.

The vehicle seat is not limited by the directions shown in the drawings. The directions shown in the drawings are directions in a state where the vehicle seat according to the below-described embodiments is mounted in the automobile. The drawings provided with hatched lines do not necessarily represent sectional views.

A member or a portion described at least with a reference numeral is at least one in number except in a case of being accompanied by a restrictive wording such as “only one”. In other words, the member or the portion may be two or more in number in a case of not being accompanied by the restrictive wording such as “only one”. The vehicle seat indicated in the present disclosure comprises at least one of (i) an element such as a member or a portion described at least with a reference numeral or (ii) a structural portion shown in the drawings.

### FIRST EMBODIMENT

### 1. Overview of Vehicle Seat

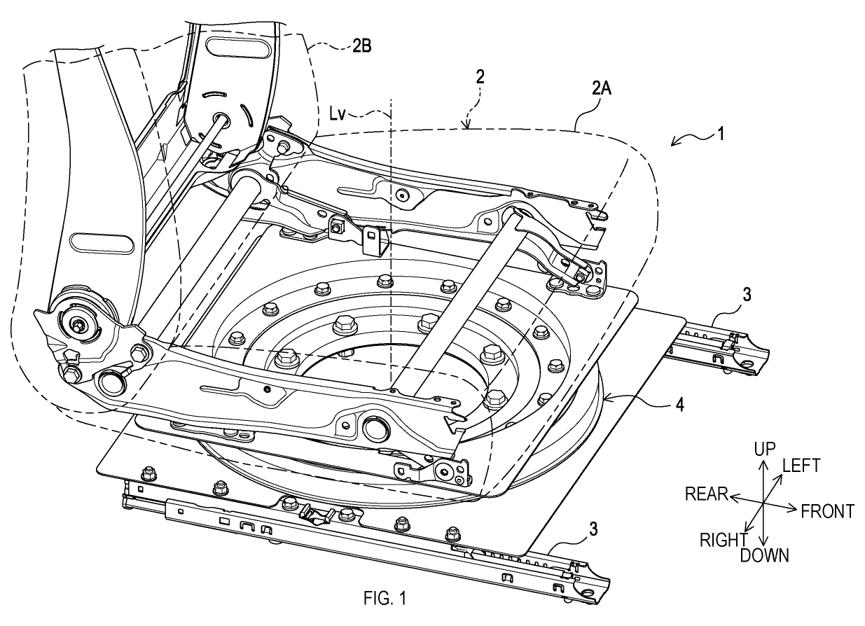

As shown in FIG. 1, a vehicle seat 1 comprises at least a seat body 2 and a rotary support device 4. The seat body 2 comprises at least a seat cushion 2A. The seat cushion 2A is a member for supporting the buttocks of an occupant.

In the present embodiment, a seatback 2B is provided on a rear-end side of the seat cushion 2A. The seatback 2Bis a member for supporting the back of the occupant. The seatback 2B is pivotable relative to the seat cushion 2A.

The rotary support device 4 rotatably supports the seat body 2 such that the seat body 2 rotates about a vertical axis Lv. The rotary support device 4 is fixed to a vehicle via two slide mechanisms 3.

The two slide mechanisms 3 slidably support the vehicle seat 1. The two slide mechanisms 3 are spaced apart from each other in a direction parallel to a vehicle width direction.

### 2. Details of Rotary support device

### 2.1. Configuration of Rotary Support Device

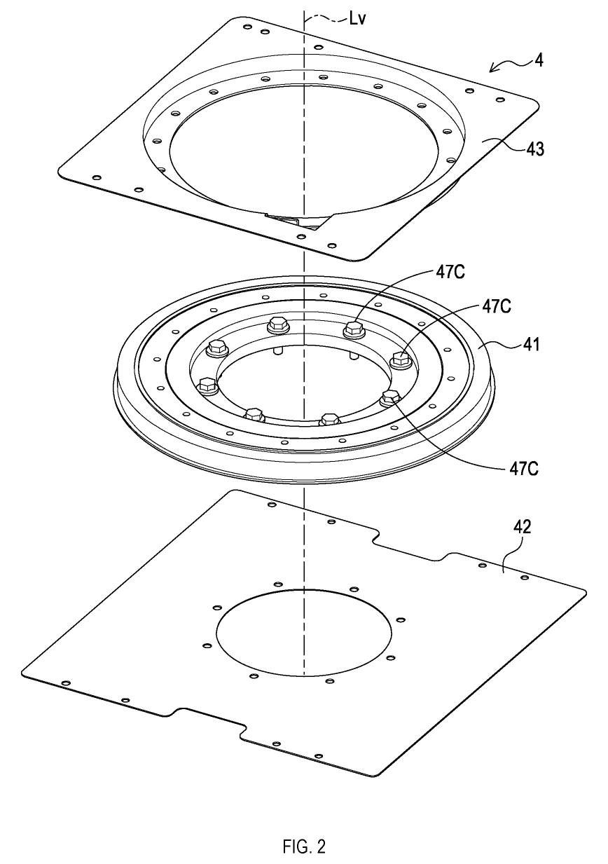

As shown in FIG. 2, the rotary support device 4 comprises at least a device body 41, a lower plate 42, and an upper plate 43. The lower plate 42 is a member for coupling the device body 41 to the two slide mechanisms 3. The upper plate 43 is a member for coupling the device body 41 to the seat body 2.

### 2.2. Configuration of Device Body

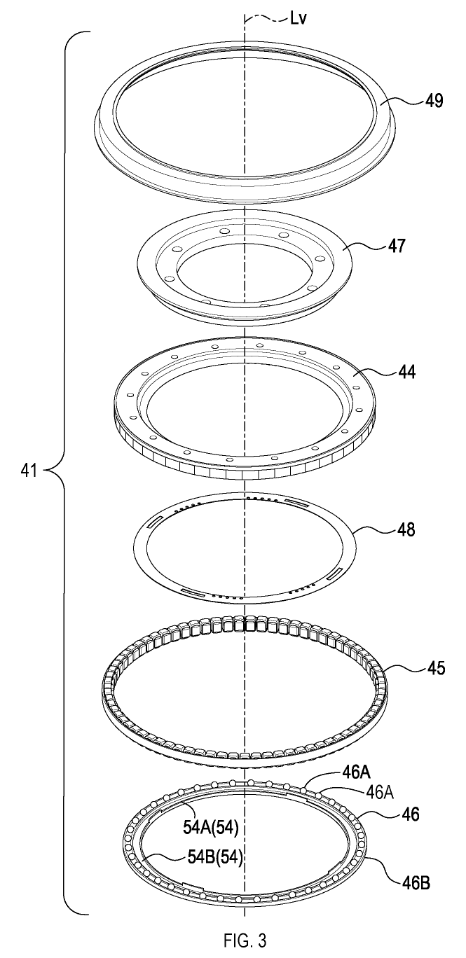

As shown in FIG. 3, the device body 41 comprises at least a rotary support 44, a stator 45, a thrust bearing 46, a guide block 47, a lock ring 48, and a cover 49.

### Rotary support and Stator

The rotary support 44 is a rotating member that supports the seat body 2 so as to be rotatable about the vertical axis Lv, and constitutes an electric motor in cooperation with the stator 45. That is, the rotary support 44 is a member that functions also as a rotor of the electric motor.

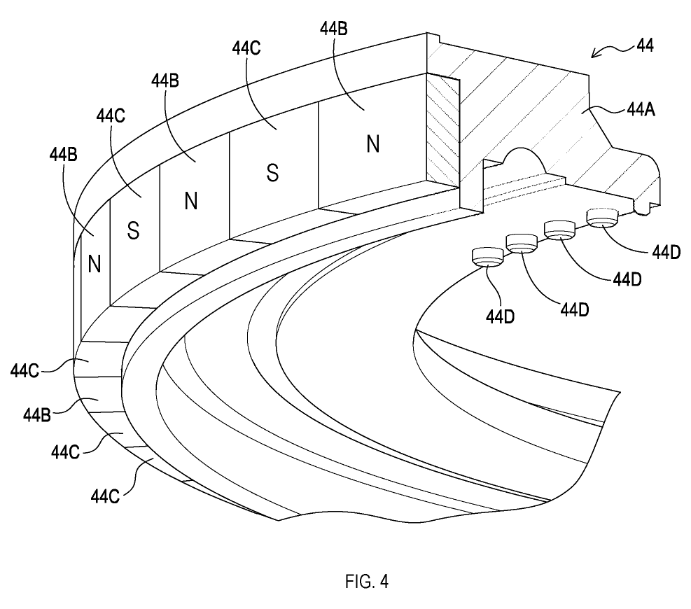

As shown in FIG. 4, the rotary support 44 comprises a core portion 44A, and permanent magnets 44B and 44C. The core portion 44A is a ring-shaped member made of an iron-based metallic material having excellent magnetization properties.

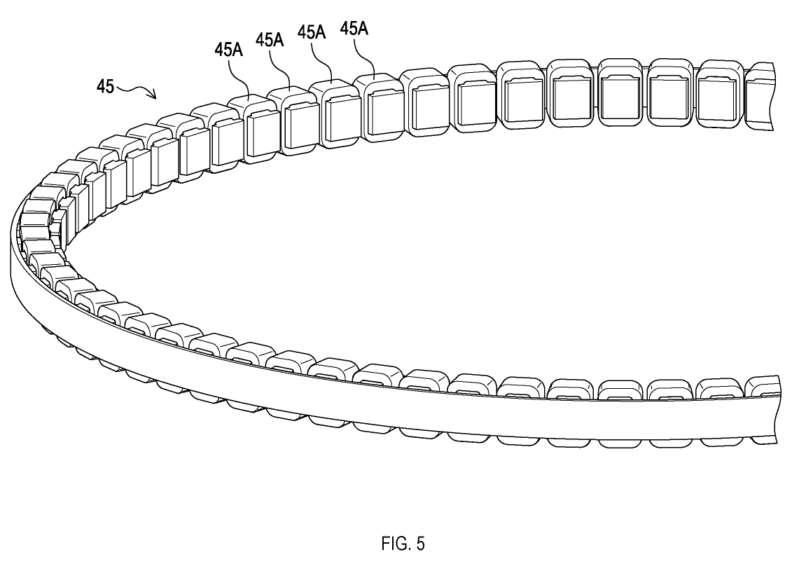

The permanent magnets 44B and 44C are arranged at locations, on the core portion 44A, facing stator coils 45A (see FIG. 5). Specifically, the permanent magnets 44B and 44C are fixed onto an outer peripheral surface of the core portion 44A such that N-poles and S-poles are alternately generated along the outer peripheral surface (see FIG. 4).

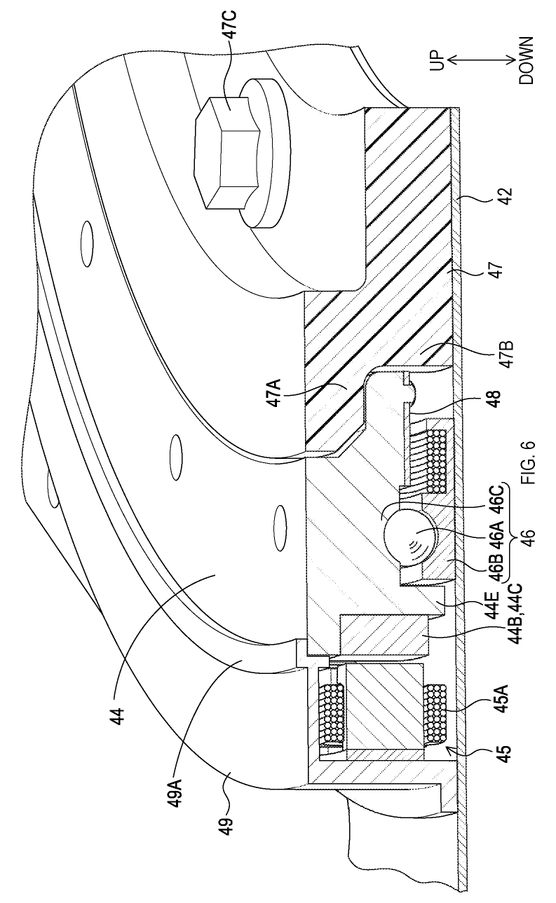

The stator 45 is a magnetic field generator that generates a rotating magnetic field centered on the vertical axis Lv around the rotary support 44. As shown in FIG. 5, the stator 45 is provided with the stator coils 45A arranged so as to surround an outer peripheral side of the rotary support 44. As shown in FIG. 6, the stator 45 is covered by the cover 49.

The cover 49 is provided with a covering portion 49A that covers a part of an upper surface of the rotary support 44 located on an outer peripheral side thereof. The covering portion 49A is a stepped portion that inhibits entry of foreign matter into the inside. The rotary support 44 comprises a wall 44E that inhibits entry of foreign matter into a space where rolling elements 46A of the thrust bearing 46 are located.

Energization of the respective stator coils 45A is controlled by a controller (not shown). The controller controls energization of the respective stator coils 45A so as to generate the rotating magnetic field. In the present embodiment, the rotary support 44, the stator 45, and so on constitute a brushless DC motor.

### Thrust Bearing

The thrust bearing 46 supports the rotary support 44 while receiving a load applied in a direction parallel to the vertical axis Lv. As shown in FIG. 6, the thrust bearing 46 comprises the rolling elements 46A (steel balls in the present embodiment), a lower-side bearing ring 46B, and an upper-side bearing ring 46C.

The rolling elements 46A are in rolling contact with the rotary support 44 to support the rotary support 44. The lower-side bearing ring 46B is an annular member with which respective lower portions of the rolling elements 46A are in rolling contact, and guides rolling of the rolling elements 46A.

The upper-side bearing ring 46C is an annular member with which respective upper portions of the rolling elements 46A are in rolling contact, and guides rolling of the rolling elements 46A. For this purpose, the lower-side bearing ring 46B and the upper-side bearing ring 46C are each provided with a groove having a cross-sectional shape of a substantially semicircle.

The rolling elements 46A are arranged in the groove. The upper-side bearing ring 46C according to the present embodiment is integral with the core portion 44A of the rotary support 44. In other words, the core portion 44A is provided with the groove with an annular shape forming the upper-side bearing ring 46C.

### Guide Block

As shown in FIG. 6, the guide block 47 restrains the rotary support 44 from being displaced in a direction different from its rotational direction, thereby guiding the rotary support 44 to rotate in a specific direction.

Specifically, the guide block 47 comprises an upper restraining portion 47A, and a horizontal restraining portion 47B. The upper restraining portion 47A restrains upward displacement of the rotary support 44. Specifically, the upper restraining portion 47A restrains the upper-side bearing ring 46C from being spaced apart from the rolling elements 46A.

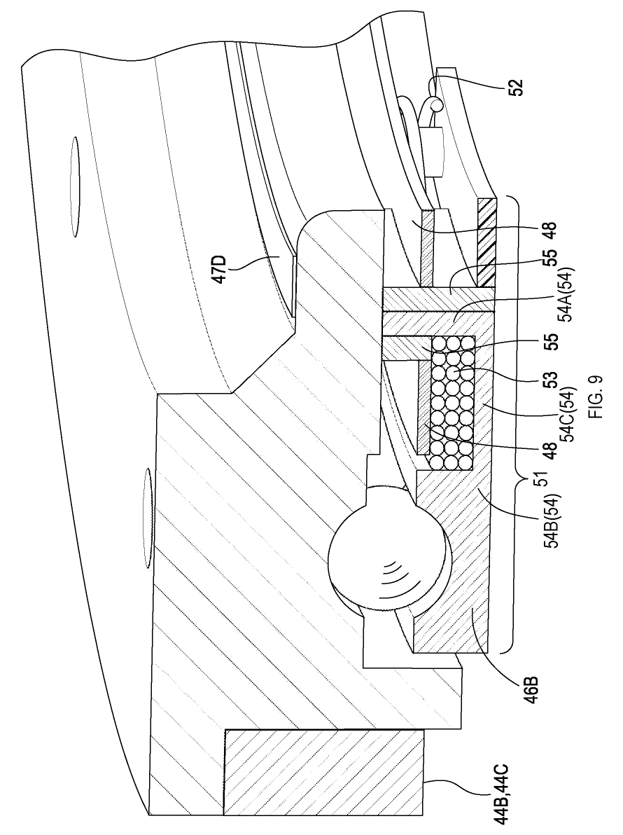

The upper restraining portion 47A and the rotary support 44 are in indirect sliding contact with each other via a sliding sheet 47D (see FIG. 9) at a location where they face each other. As shown in FIG. 6, the horizontal restraining portion 47B restrains horizontal displacement of the rotary support 44.

Downward displacement of the rotary support 44 is restrained by the thrust bearing 46. Thus, the rotary support 44 rotates about the vertical axis Lv in a state where its upward and horizontal displacements are restrained by the guide block 47.

The guide block 47 is fixed to the lower plate 42 with bolts 47C. As shown in FIG. 2, the bolts 47C are arranged at substantially equal intervals along an imaginary circle centered on the vertical axis Lv.

### Lock Ring. Lock Mechanism

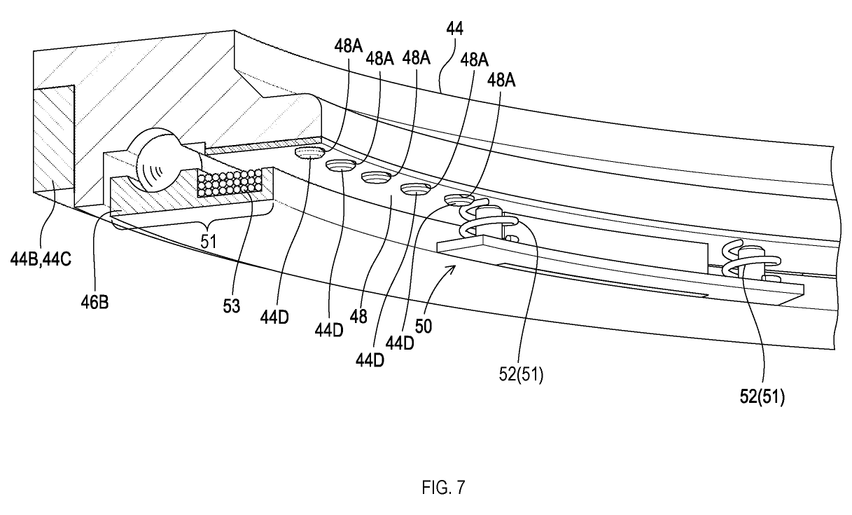

As shown in FIG. 7, the lock ring 48 is one of the components forming a lock mechanism 50. The lock mechanism 50 is a mechanism for restraining rotation of the rotary support 44. The lock mechanism 50 comprises the lock ring 48 and an actuator 51.

The lock ring 48 is one example of a lock member and shifts between a locking position and a non-locking position. The locking position refers to a position in which, as shown in FIG. 7, the lock ring 48 and an engagement portion 44D provided on the rotary support 44 are mutually engageable.

Specifically, the engagement portion 44D is configured with one or more protrusions protruding downward from a lower surface of the rotary support 44. The lock ring 48 is provided with one or more recessed portions 48A (one or more through-holes in the present embodiment) into each of which a corresponding one of the one or more protrusions forming the engagement portion 44D is fittable. The number of the one or more recessed portions 48A is equal to or greater than the number of the one or more protrusions.

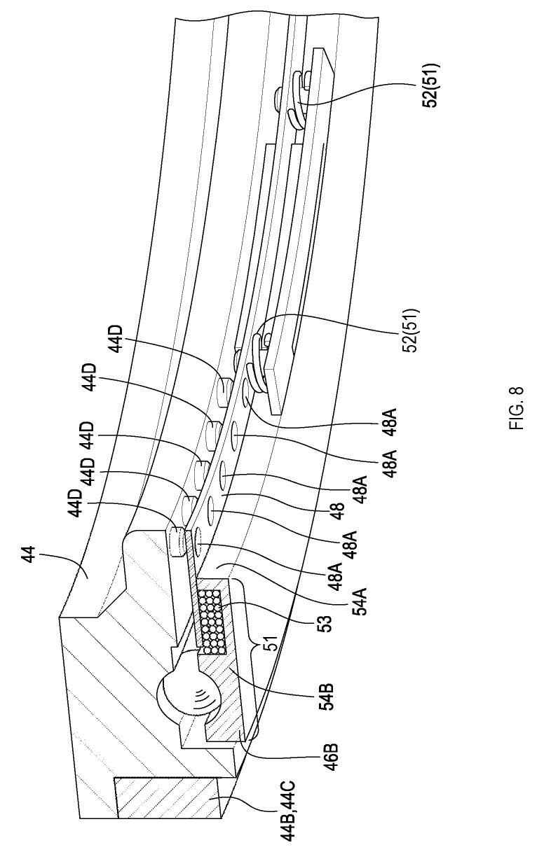

The non-locking position refers to a position in which, as shown in FIG. 8, the engagement between the lock ring 48 and the engagement portion 44D is released. Specifically, the non-locking position is a position in which the one or more protrusions forming the engagement portion 44D is/are disengaged from the one or more recessed portions 48A.

The actuator 51 shifts the position of the lock ring 48. The actuator 51 according to the present embodiment is configured with an electromagnetic actuator (an electromagnet) generating an electromagnetic attraction force that attracts the lock ring 48 to the non-locking position.

Specifically, as shown in FIG. 9, the actuator 51 comprises at least a solenoid coil 53, a fixed iron core portion 54 (also called a yoke), and a return spring 52.

The solenoid coil 53 induces a magnetic field. The solenoid coil 53 is a wire wound in a coil shape about the vertical axis Lv.

The fixed iron core portion 54 forms part of a magnetic path of a magnetic flux induced by the solenoid coil 53. The fixed iron core portion 54 comprises a first yoke part 54A and a second yoke part 54B. The first yoke part 54A is a cylindrical part located on an inner peripheral side of the solenoid coil 53 (see FIG. 3).

The second yoke part 54B is located on an outer peripheral side of the solenoid coil 53. As shown in FIG. 9, the second yoke part 54B is a one-piece article integral with the lower-side bearing ring 46B and of the same material as the lower-side bearing ring 46B.

The second yoke part 54B, that is, the lower-side bearing ring 46B, and the first yoke part 54A are coupled to each other via a third yoke part 54C. Thus, the entirety of the fixed iron core portion 54 according to the present embodiment is a one-piece article integral with the lower-side bearing ring 46B and of the same material as the lower-side bearing ring 46B.

### Operation of Lock Mechanism

When the solenoid coil 53 is energized, the upper-side bearing ring 46C, that is, the rotary support 44, becomes magnetized. This causes the lock ring 48, which constitutes an armature (a movable iron core portion), to be attracted to the first yoke part 54A, thereby shifting to the non-locking position as shown in FIG. 8.

At this time, the return spring 52 undergoes compressive deformation, and thus, when the solenoid coil 53 is de-energized, the lock ring 48 returns to the locking position due to a restoring force of the return spring 52 as shown in FIG. 7.

That is, in the present embodiment, while the solenoid coil 53 is not energized, the lock ring 48 is in the locking position, thus restraining rotational displacement of the rotary support 44. While the solenoid coil 53 is energized, the lock ring 48 is in the non-locking position, thus allowing the rotary support 44 to rotate.

As shown in FIG. 9, there is provided a sliding guide member 55, which guides a positional shift of the lock ring 48 by being in sliding contact with the lock ring 48 when the lock ring 48 shifts between the non-locking position and the locking position.

### 3. Features of Vehicle Seat

In the vehicle seat 1, the rotary support 44 rotatably supporting the seat body 2 functions also as a rotor of the electric motor. This eliminates, in the vehicle seat 1, the need for a reducer and reducing gears, such as a smaller gear and a larger gear.

Specifically, the diameter of the rotary support 44 is dimensioned according to the width of the seat body 2. Thus, the diameter of the rotary support 44, that is, the diameter of the rotor is dimensioned to be extremely large compared with that in a common electric motor used for the vehicle seat 1.

Accordingly, even when the height of the rotary support 44, that is, the axial dimension of the rotor is small, sufficient torque that can rotate the seat body 2 is generated in the rotary support 44. This in turn may enable, in this vehicle seat, a reduction in the number of components and a reduction in the height.

In the meantime, in a configuration, as in the invention disclosed in Japanese Unexamined Patent Application Publication No. 2024-8789, in which a power transmission path from the electric motor to the rotatable plate is constantly continuous via multiple gears, it is effectively impossible to rotate the rotatable plate manually.

To cope with this, a configuration in which a clutch is provided along the power transmission path would make it possible to rotate the rotatable plate manually. However, such a configuration would result in an increase in the number of components and a further increase in the height.

In this respect, the rotary support 44 in the vehicle seat 1 is a rotor of the electric motor, and thus, while the stator coils 45A are not energized, the rotary support 44 can, in principle, rotate with no restraint. Accordingly, since no clutch is required for this vehicle seat, issues such as an increase in the number of components and an increase in the height caused by addition of a clutch do not arise.

The lock mechanism 50 is configured with the lock ring 48 engageable with the engagement portion 44D provided on the rotary support 44, and the actuator 51 shifting the position of the lock ring 48. In the vehicle seat 1, this enables the size reduction while inhibiting an increase in the number of components.

The fixed iron core portion 54 forming the magnetic path in the actuator 51 is a one-piece article integral with the lower-side bearing ring 46B and of the same material as the lower-side bearing ring 46B. In the vehicle seat 1, this enables the size reduction while inhibiting an increase in the number of components.

### OTHER EMBODIMENTS

In the above-described embodiment, the fixed iron core portion 54 and the lower-side bearing ring 46B are a one-piece article in which they are integral with each other. However, the present disclosure is not limited thereto. For example, the fixed iron core portion 54 and the lower-side bearing ring 46B may be separate.

In the above-described embodiment, the stator 45 is arranged on the outer peripheral side of the rotary support 44. However, the present disclosure is not limited thereto. For example, the stator 45 may be arranged on an inner peripheral side of the rotary support 44.

In the above-described embodiment, the rotary support 44 and the stator 45 constitutes the electric motor, which is a so-called brushless DC motor. However, the present disclosure is not limited thereto. For example, the rotary support 44 and the stator 45 may constitute a so-called stepper motor.

The rolling elements 46A in the above-described embodiment are spherical steel balls. However, the present disclosure is not limited thereto. For example, the rolling elements may be cylindrical rollers or tapered rollers.

In the above-described embodiment, the permanent magnets are arranged on the rotary support 44. However, the present disclosure is not limited thereto. For example, the permanent magnets may be omitted, and an electric motor utilizing reluctance torque (magnetic resistance torque) may be employed instead.

In the above-described embodiment, an example in which the vehicle seat is applied to an automobile is described. However, application of the disclosure disclosed herein is not limited thereto. For example, the present disclosure is also appliable to seats used in vehicles, such as railroad vehicles, ships, or aircraft, and to stationary seats used in theaters, at home, or in other places.

Moreover, it is sufficient that the present disclosure be consistent with the gist of the disclosure described in the above-described embodiments, and the present disclosure is not limited by the above-described embodiments. Therefore, a configuration may be employed in which at least two embodiments among the above-described embodiments are combined together or in which any of the elements shown in the drawings or the elements described with reference numerals is omitted in the above-described embodiments.

What is claimed is:

1. A vehicle seat to be mounted in a vehicle, the vehicle seat comprising:
a rotary support configured to rotatably support a seat body about a vertical axis, the rotary support functioning also as a rotor of an electric motor; and
stator coils configured to generate a rotational force in the rotary support.

2. The vehicle seat according to claim 1, further comprising:
a lock mechanism configured to restrain rotation of the rotary support,
wherein the lock mechanism includes:
a lock member configured to shift between a locking position and a non-locking position, the locking position being a position in which the lock member is engaged with an engagement portion provided on the rotary support, and the non-locking position being a position in which such engagement is released; and
an actuator configured to shift a position of the lock member.

3. The vehicle seat according to claim 2, further comprising:
rolling elements configured to be in rolling contact with the rotary support to support the rotary support; and
a bearing ring with an annular shape, with which the rolling elements are in rolling contact, the bearing ring being configured to guide rolling of the rolling elements,
wherein the actuator is an electromagnetic actuator generating an electromagnetic force and includes a fixed iron core portion forming a magnetic path in the actuator, the fixed iron core portion being a one-piece article integral with the bearing ring and of a same material as the bearing ring.

4. The vehicle seat according to claim 1,
wherein a portion of the rotary support facing the stator coils has permanent magnets arranged thereon.
